(19) United States
(12) Patent Application Publication
(10) Pub. No.: US 2015/0314429 A1
(43) Pub. Date: Nov. 5, 2015

(54) Anti-slip Fastener Remover

(71) Applicant: Robert S. Doroslovac, Massillon, OH (US)

(72) Inventor: Robert S. Doroslovac, Massillon, OH (US)

(21) Appl. No.: 14/701,482

(22) Filed: Apr. 30, 2015

Related U.S. Application Data
(60) Provisional application No. 61/986,327, filed on Apr. 30, 2014.

(51) Int. Cl. B25B 27/18; B25B 15/00; B25B 13/06

(52) U.S. Cl. CPC B25B 27/18; B25B 13/06; B25B 15/004

(57) ABSTRACT

A fastener extractor that utilizes a plurality of engagement features to prevent slippage and facilitate torque transfer to the fastener. The fastener extractor includes a torque-tool body and a plurality of engagement features. The torque-tool body is the physical structure used to apply the corresponding force by the plurality of engagement features. Each engagement feature includes a flank line, a transversal line, and a basin line. The flank and the transversal line make up the portion of the feature which directly engages the lateral surfaces of the fastener. The basin line and the transversal line are used to create a complimentary shape tailored to the fastener's design to facilitate a proper fit over or into the fastener.

The current application claims a priority to the U.S. Provisional Patent application Ser. No. 61/986,327 filed on Apr. 30, 2014.

### FIELD OF THE INVENTION

The present invention relates generally to tools designed for tightening or loosening fasteners, in particular bolts and nuts. More specifically, the present invention is an anti-slip wrench or wrench socket designed to extract stripped bolts, nuts, and other similar fasteners.

### BACKGROUND OF THE INVENTION

Hex bolts, nuts, screws, and other similar threaded devices are used to secure and hold multiple parts together by being engaged to a complimentary thread, known as a female thread. The general structure of a these types of fasteners is a cylindrical shaft with an external thread and a head at one end of the shaft. The external thread engages a complimentary female thread tapped into a hole or a nut and secures the fastener in place, binding the associated components together. The head is the means by which the fastener is turned, or driven, into the female threading. The head is shaped specifically to allow an external tool like a wrench to apply a torque to the fastener in order to rotate the fastener and engage the complimentary female threading to a certain degree. This type of fastener is simple, extremely effective, cheap, and highly popular in modern construction.

One of the most common problems in using these types of fasteners, whether male or female, is the tool slipping in the head portion, or slipping on the head portion. This is generally caused by either a worn fastener or tool, corrosion, overtightening, and damage to the head portion of the fastener. The present invention is a wrench or wrench socket design that virtually eliminates slippage. The design uses a bevel edge design that bites into the head of the fastener and allows for torque to be applied to the fastener in order to loosen it. The present invention eliminates the need for the common bolt extractors as they require unnecessary drilling and tools.

### BRIEF DESCRIPTION OF THE DRAWINGS

FIG. 1 is a perspective view of socket embodiment of the present invention.

FIG. 2 is a side-view of the socket embodiment of the present invention.

FIG. 3A is a sectional view about the section line A-A depicted in FIG. 2.

FIG. 3B is a sectional view about the section line A-A depicted in FIG. 2 without the torque-tool body and the attachment body.

FIG. 4 is a detailed view taken about the oval Y depicted in FIG. 3A.

FIG. 5 is a rear perspective view of socket embodiment of the present invention.

FIG. 6 is a perspective view of a shank embodiment of the present invention.

FIG. 7 is a perspective view of a wrench embodiment of the present invention.

FIG. 8 is a perspective view of an alternative shank embodiment of the present invention.

FIG. 9 is a perspective view of an alternative socket embodiment of the present invention.

### DETAIL DESCRIPTIONS OF THE INVENTION

All illustrations of the drawings are for the purpose of describing selected versions of the present invention and are not intended to limit the scope of the present invention.

The present invention is an anti-slip fastener remover. More specifically, the present invention is an anti-slip profile for the engagement portion of a torque tool which facilitates fastener extraction, in particular nuts and bolts. The present invention utilizes a multitude of beveled teeth to engage the sides of a damaged or stripped fastener head in order to apply torque and extract the fastener. The present invention may be integrated into or utilized by a variety of general tools to increase the torque force applied to the fastener. General tools include, but are not limited to, screw drivers, hex keys, open-end wrenches, adjustable wrenches, pipe wrenches, socket wrenches, plumber wrench, and other similar torque tools. While the present invention is described in relation to different types of hex bolt fasteners, this is in no way meant to limit the scope of the invention.

The present invention may be altered and configured to fit different types of fasteners. Furthermore, the present invention is also compatible with both female-member and male-member based head designs of fasteners. Fasteners which utilize a male-member head design, also known as male fasteners, use the external lateral surface of the head to engage a tool for tightening or loosening, such fasteners include hex bolts and nuts. Fasteners which utilize a female-member head design, also known as female fasteners, use the internal lateral surfaces of a receptive cavity to engage a shank with complimentary design for tightening or loosening. An example of a female fastener is a bolt with a hex shaped cavity in the head portion. In addition, the present invention is compatible with fasteners of a right-hand thread and fasteners of a left-hand thread.

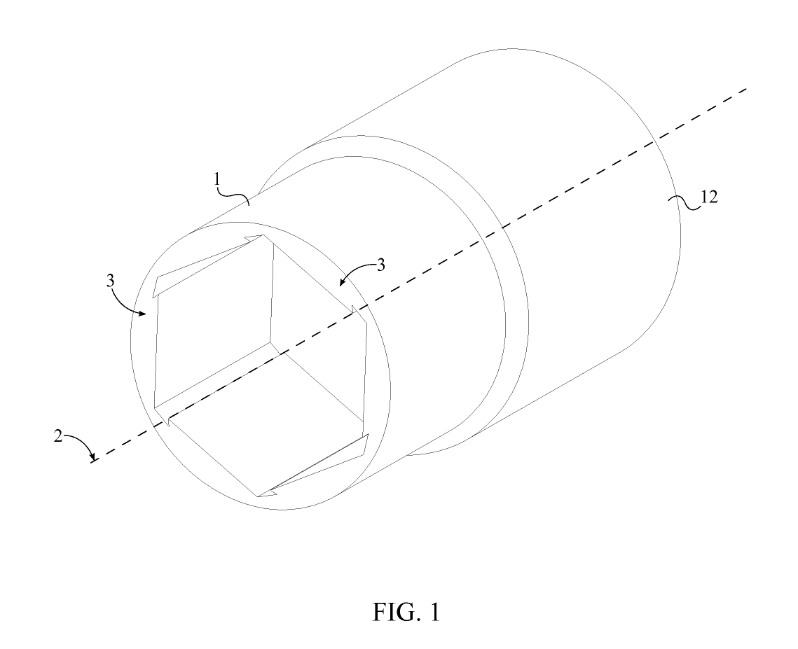

Referring to FIG. 1, the present invention comprises a torque-tool body 1 and a plurality of engagement features 3. The torque-tool body 1 is used as the physical structure to apply the corresponding force by the plurality of engagement features 3 on the head of a fastener. For a male fastener, the torque-tool body 1 is a tubular extrusion sized to fit over the male fastener in an interlocking manner, similar to a wrench socket.

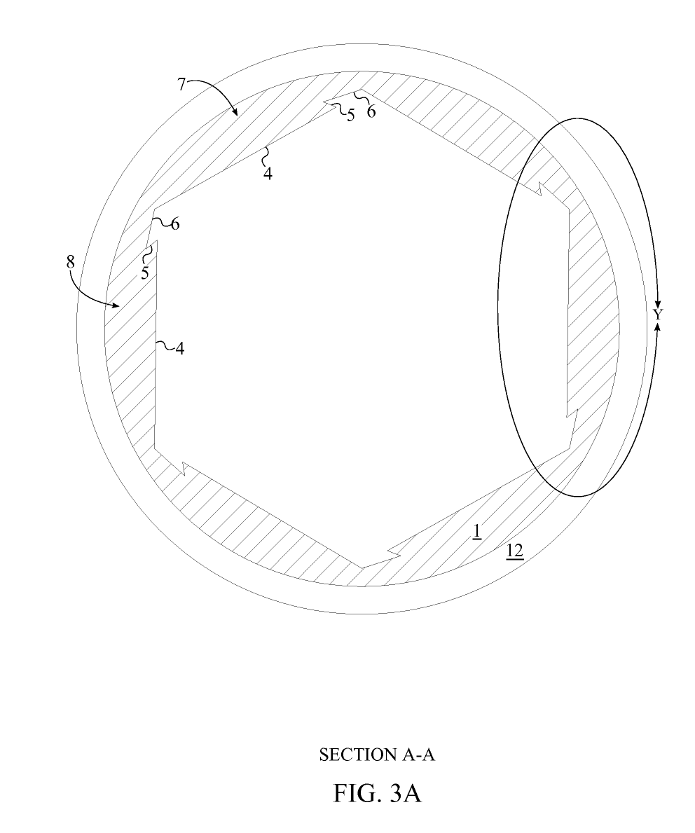

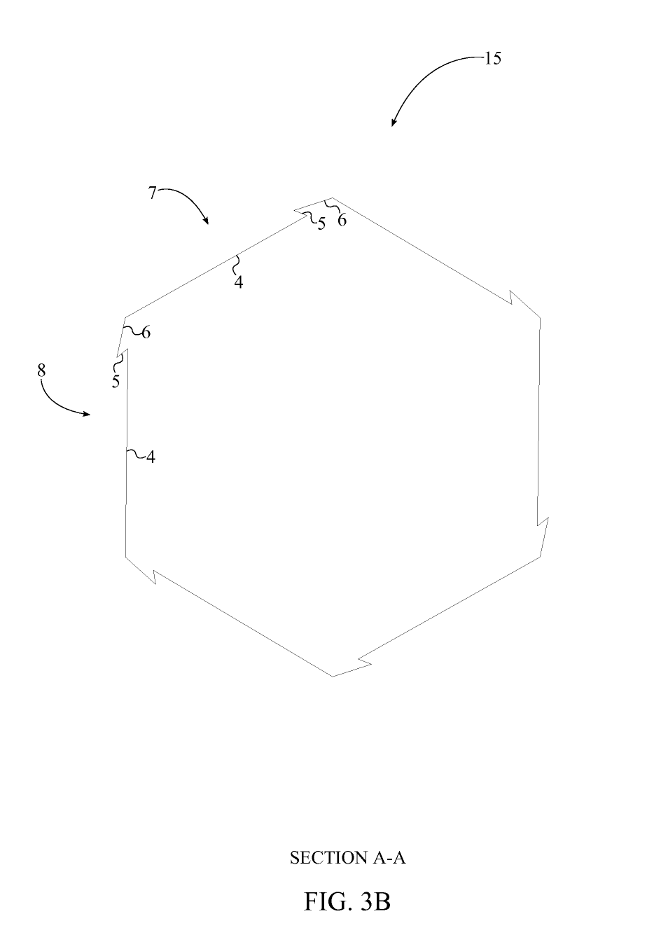

For a female fastener, the torque-tool body 1 is a shank sized to fit inside the receptive bore of the fastener in an interlocking manner, similar to a hex key. The length, width, and diameter of the torque-tool body 1 may vary to fit different sized fasteners. The plurality of engagement features 3 prevent slippage during fastener extraction and is radially positioned around a rotation axis 2 of the torque-tool body 1 as seen in FIG. 3B.

The plurality of engagement features 3 grip the lateral surfaces of the fastener head to facilitate the transfer of torque to the fastener by preventing slippage between the torque-tool body 1 and the fastener.

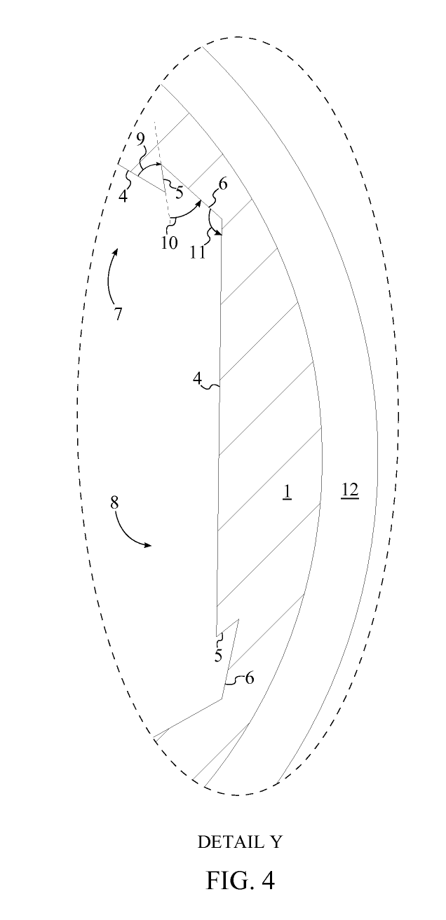

Referring to FIG. 3B, FIG. 3A, and FIG. 4, a cross section 15 for each of the plurality of engagement features 3 comprises a flank line 4, a transversal line 5, and a basin line 6. The flank line 4 is adjacently connected to the transversal line 5 at a first acute angle 9 resulting in a tooth-like design. The tooth-like shape digs into the lateral surface of the fastener and prevents slippage of the torque-tool body 1 relative to the fastener. The basin line 6 is adjacently connected to the transversal line 5 at a second acute angle 10, opposite the flank line 4. The basin line 6 and the transversal line 5 make up a corner that corresponds to a corner of the fastener's head, thus facilitating a proper fit. The plurality of engagement features 3 is equally spaced about the torque-tool body 1 to create an enclosed profile as seen in FIG. 3A and FIG. 4. The length of the transversal line 5, the flank line 4, and the basin line 6 may change. Similarly, the first acute angle 9 and second acute angle 10 may vary to create a sharper tooth-like shape. The plurality of engagement features 3 comprises an arbitrary engagement feature 7 and an adjacent engagement feature 8. The basin line 6 of the arbitrary engagement feature 7 is connected to the flank line 4 of the adjacent engagement feature 8 at an obtuse angle 11, opposite to the transversal line 5 of the adjacent engagement feature 7 as seen in FIG. 4. The arbitrary engagement feature is any feature within the plurality of engagement features 3 the adjacent engagement feature 8 is the feature directly next to that any feature. As mentioned above, the present invention may be designed to fit a variety of fastener designs. This is achieved by varying the number of engagement features within the plurality of engagement features 3 to compliment different types of fastener designs. The number of engagement features within the plurality of engagement features 3 corresponds to the number of sides of the fastener's head. For instance, for a pentagon shaped fastener there are five engagement features within the plurality of engagement features 3. A hexagon shaped fastener requires six engagement features within the plurality of engagement features 3, an example is seen in FIG. 3A.

In one embodiment of the present invention, the torque-tool body 1 is outwardly extended from the cross section 15 of the plurality of engagement features 3 as seen in

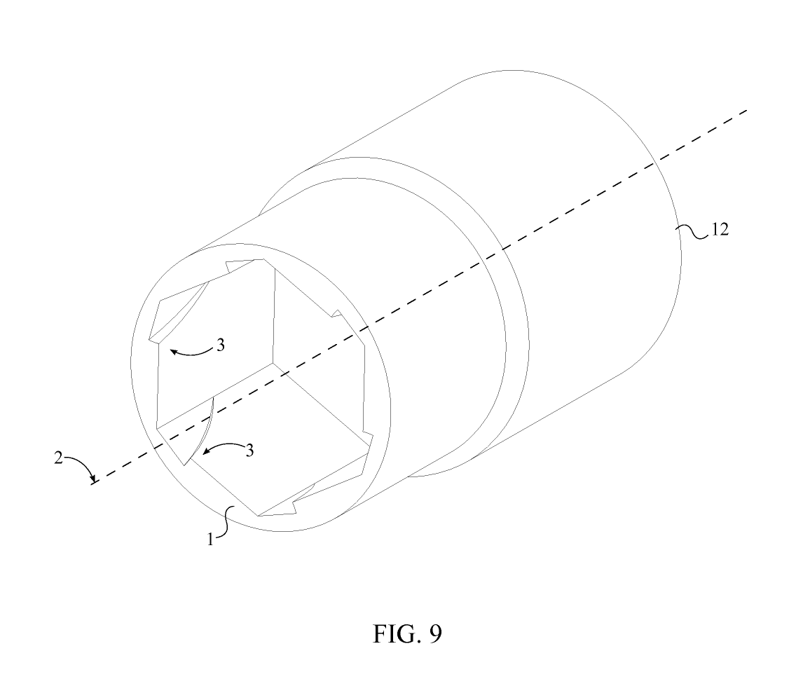

FIG. 1 and FIG. 3. This yields a socket-like structure with the plurality of engagement features 3 distributed about the rotation axis 2 on the internal surface of the torque-tool body 1, similar to a wrench socket. Additionally, each of the plurality of engagement features 3 is extended along the length of the torque-tool body 1 as seen in FIG. 1. Alternatively, each feature from the plurality of engagement features 3 may taper off in a clockwise or counter-clockwise direction as seen in FIG. 9. The tapered design provides an additional engagement edge for the present invention. The empty space within the torque-tool body 1 acts as a receptive cavity for the fastener head. This embodiment is for extracting male fasteners. For a male fastener with a right-hand thread, each of the plurality of engagement features 3 is oriented in a clockwise direction from the front perspective as seen in FIG. 3. In particular, the tooth-like extrusion created by the flank line 4 and the transversal line 5 is pointed along a clockwise direction when viewed from the front perspective. To remove a male fastener with this embodiment, the torque-tool body 1 is positioned onto the head of the fastener such that at least a portion of the fastener head is located within the receptive cavity of the torque-tool body 1. The user then simply applies a counter-clockwise torque force to the torque-tool body 1 in order to rotate and remove the fastener. When a torque force is applied to the torque-tool body 1, the plurality of engagement features 3 “bite” the lateral sides of the fastener head which in turn rotates the fastener. For a male fastener with a left-hand thread, the direction of the torque force and each of the plurality of engagement features 3 is reversed.

A traditional socket wrench design transfers the majority of the torque to the fastener through the lateral corners of the fastener head. Over time, the degradation of the lateral corners reduces the efficiency of transferring torque from the socket wrench to the fastener head and, as a result, causes slippage. The present invention overcomes this problem by moving the torque transfer point to the lateral sides of the fastener head. This is accomplished through the use of the plurality of engagement features 3. Each of the plurality of engagement features 3 is positioned to engage or “bite” the lateral surface of the fastener head instead of the lateral corner. This ensures an adequate amount of torque is transferred to the fastener head to initiate rotation and, resultantly, extraction of the fastener.

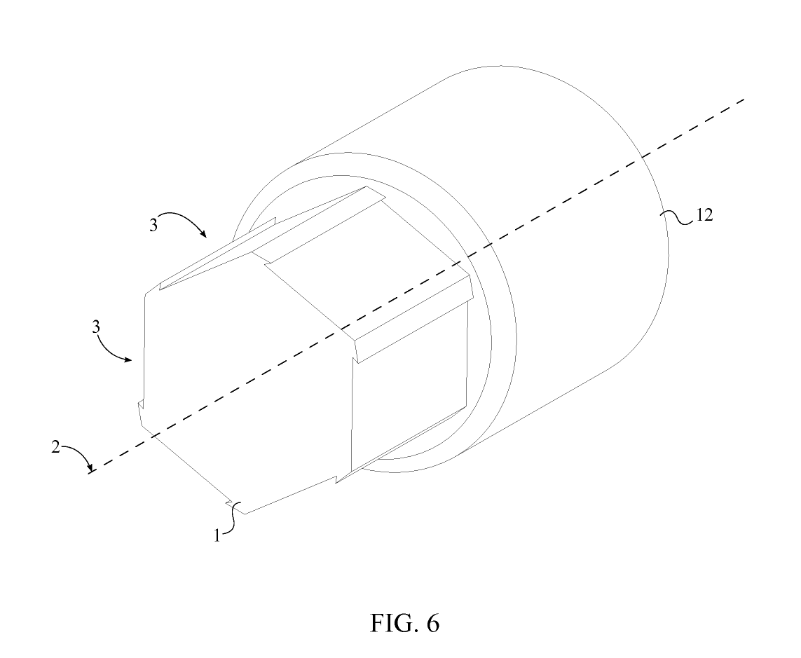

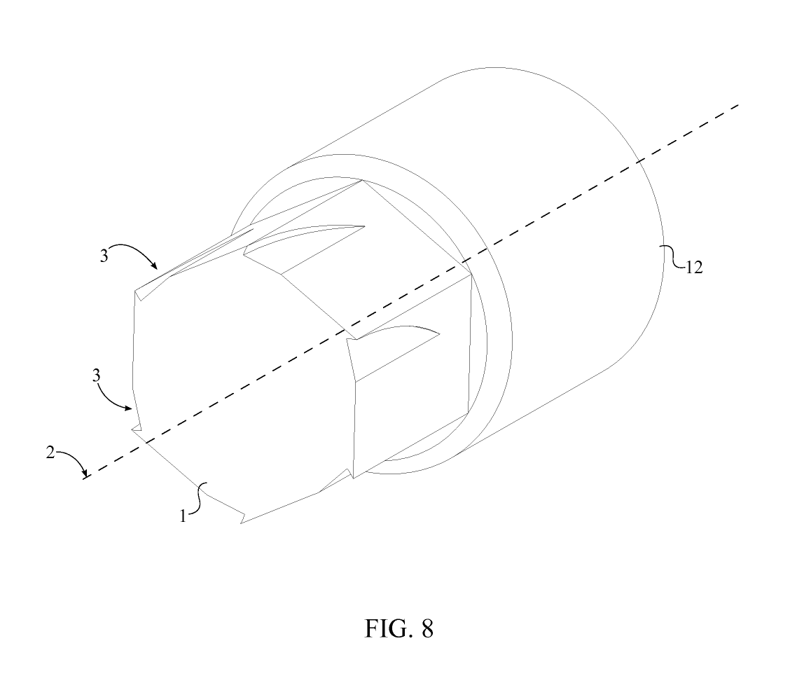

In another embodiment of the present invention, the torque-tool body 1 is laterally delineated by the cross section 15 of the plurality of engagement features 3. This yields a shank-like structure with the plurality of engagement features 3 distributed about the rotation axis 2 on the external lateral surface as seen in FIG. 6, similar to a hex key. The plurality of engagement features 3 may extend fully or partially along the length of the torque-tool body 1. Alternatively, each feature from the plurality of engagement features 3 may taper off in a clockwise or counter-clockwise direction as seen in FIG. 8. This design reduces manufacturing costs and facilitates a self-cleaning design. This embodiment is for extracting female fasteners, a fastener with a socket in the head portion. To remove a female fastener with this embodiment, the torque-tool body 1 is positioned into the socket of the fastener head such that at least a significant portion of the torque-tool body 1 is located within the receptive cavity. The user then simply applies a counter-clockwise torque force to the torque-tool body 1 in order to rotate and remove the fastener. When a torque force is applied to the torque-tool body 1, the plurality of engagement features 3 “bite” into the lateral sides of receptive cavity which in turn rotates the fastener. This embodiment is designed to engage partially or fully stripped female fasteners. A stripped female fastener is when the internal lateral surfaces of the receptive cavity are deformed and rounded to such a degree that traditional tools like a hex key slip within the receptive cavity and cannot rotate the fastener. The present invention overcomes this problem through the use of the plurality of engagement features 3. Because each of the plurality of engagement features 3 is an angled tooth extrusion, when the torque-tool body 1 is rotated within the receptive cavity the plurality of engagement features 3 digs into the lateral surface of the receptive cavity and facilitate the transfer of torque to the fastener.

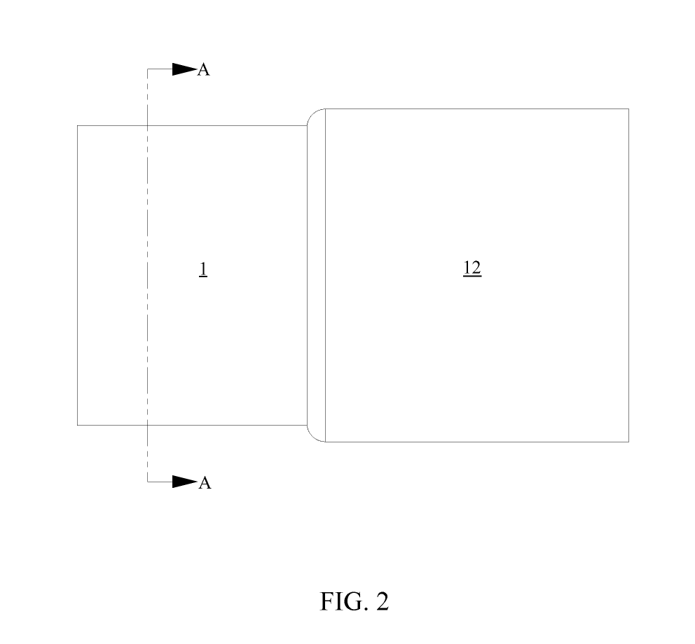

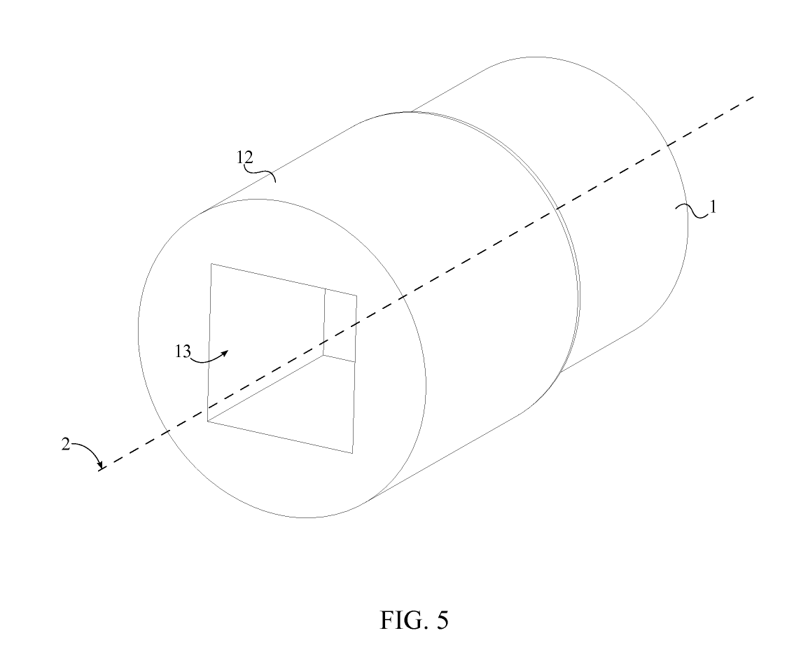

The present invention also incorporates an attachment feature which allows an external torque tool to attach to the torque-tool body 1 and increase the torque force applied to the fastener. Referring to FIG. 5, the present invention comprises an attachment body 12 and an engagement bore 13 that allow an external tool such as a socket wrench to be attached to the torque-tool body 1. The attachment body 12 is centrally positioned around and along the rotation axis 2 in order to align with the axis of rotation of the torque tool, and the attachment body 12 is connected adjacent to the torque-tool body 1 as seen in FIG. 2. The attachment body 12 is preferably of a cylindrical design with a diameter slightly larger than the diameter of the torque-tool body 1. The engagement bore 13 traverses into the attachment body 12 along the rotation axis 2, opposite the torque-tool body 1. The engagement bore 13 is shaped to receive a male attachment member of a socket wrench; the preferred shape is square as the majority of socket wrenches utilize a square attachment member. In alternative embodiments, the shape and design of the engagement bore 13 and the attachment body 12 may vary to be adaptable to different torque tools and different attachment means.

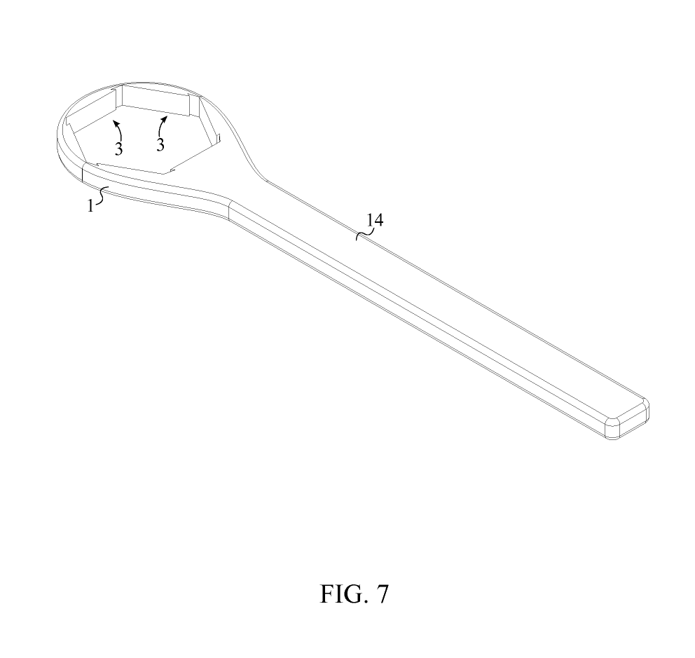

In one embodiment of the present invention, the torque-tool body 1 and the associated plurality of engagement features 3 are directly integrated into a torque tool, a wrench specifically. Referring to FIG. 7, the present invention further comprises a wrench handle 14. The wrench handle 14 is externally and laterally connected to the torque-tool body 1 and acts as a lever arm to substantially increase the torque force applied to the male fastener. The length of the wrench handle 14 may vary depending on the torque force required to remove the fastener; a longer wrench handle 14 produces a greater torque force and vice versa. Furthermore, the general shape, design, and material composition of the wrench handle 14 may also vary to accommodate the needs of the user. For example, the wrench handle 14 may be padded at various regions to alter the handling characteristics of the tool to increase ease of use and comfort for the user.

Although the invention has been explained in relation to its preferred embodiment, it is to be understood that many other possible modifications and variations can be made without departing from the spirit and scope of the invention as hereinafter claimed.

What is claimed is:

1. An anti-slip fastener remover comprises:
a torque-tool body;
a plurality of engagement features;
a cross section for each of the plurality of engagement features comprises a flank line, a transversal line, and a basin line;
the plurality of engagement features being radially positioned around a rotation axis of the torque-tool body;
the flank line being adjacently connected to the transversal line at a first acute angle; and
the basin line being adjacently connected to the transversal line at a second acute angle, opposite the flank line.

2. The anti-slip fastener remover as claimed in claim 1 comprises:
the plurality of engagement features comprises an arbitrary engagement feature and an adjacent engagement feature; and
the basin line of the arbitrary engagement feature being connected to the flank line of the adjacent engagement feature at an obtuse angle, opposite to the transversal line of the adjacent engagement feature.

3. The anti-slip fastener remover as claimed in claim 1 comprises:
the torque-tool body being outwardly extended from the cross section of the plurality of engagement features.

4. The anti-slip fastener remover as claimed in claim 3 comprises:
an attachment body;
an engagement bore;
the attachment body being centrally positioned around and along the rotation axis;
the attachment body being connected adjacent to the torque-tool body; and
the engagement bore traversing into the attachment body along the rotation axis, opposite the torque-tool body.

5. The anti-slip fastener remover as claimed in claim 3 comprises:
a wrench handle; and
the wrench handle being externally and laterally connected to the torque-tool body.

6. The anti-slip fastener remover as claimed in claim 1 comprises:
the torque-tool body being laterally delineated by the cross section of the plurality of engagement features.

7. The anti-slip fastener remover as claimed in claim 6 comprises:
an attachment body;
an engagement bore;
the attachment body being centrally positioned around and along the rotation axis;
the attachment body being connected adjacent to the torque-tool body; and
the engagement bore traversing into the body along the rotation axis, opposite the torque-tool body.

8. An anti-slip fastener remover comprises:
a torque-tool body;
a plurality of engagement features;
a cross section for each of the plurality of engagement features comprises a flank line, a transversal line, and a basin line;
the plurality of engagement features being radially positioned around a rotation axis of the torque-tool body;
the flank line being adjacently connected to the transversal line at a first acute angle;
the basin line being adjacently connected to the transversal line at a second acute angle, opposite the flank line; and
the torque-tool body being outwardly extended from the cross section of the plurality of engagement features.

9. The anti-slip fastener remover as claimed in claim 8 comprises:
the plurality of engagement features comprises an arbitrary engagement feature and an adjacent engagement feature; and
the basin line of the arbitrary engagement feature being connected to the flank line of the adjacent engagement feature at an obtuse angle, opposite to the transversal line of the adjacent engagement feature.

10. The anti-slip fastener remover as claimed in claim 8 comprises:
an attachment body;
an engagement bore;
the attachment body being centrally positioned around and along the rotation axis;
the attachment body being connected adjacent to the torque-tool body; and
the engagement bore traversing into the attachment body along the rotation axis, opposite the torque-tool body.

11. The anti-slip fastener remover as claimed in claim 8 comprises:
a wrench handle; and
the wrench handle being externally and laterally connected to the torque-tool body.

12. An anti-slip fastener remover comprises:
a torque-tool body;
a plurality of engagement features;
a cross section for each of the plurality of engagement features comprises a flank line, a transversal line, and a basin line;
the plurality of engagement features being radially positioned around a rotation axis of the torque-tool body;
the flank line being adjacently connected to the transversal line at a first acute angle;
the basin line being adjacently connected to the transversal line at a second acute angle, opposite the flank line; and
the torque-tool body being laterally delineated by the cross section of the plurality of engagement features.

13. The anti-slip fastener remover as claimed in claim 12 comprises:
the plurality of engagement features comprises an arbitrary engagement feature and an adjacent engagement feature; and
the basin line of the arbitrary engagement feature being connected to the flank line of the adjacent engagement feature at an obtuse angle, opposite to the transversal line of the adjacent engagement feature.

14. The anti-slip fastener remover as claimed in claim 12 comprises:
an attachment body;
an engagement bore;
the attachment body being centrally positioned around and along the rotation axis;
the attachment body being connected adjacent to the torque-tool body; and
the engagement bore traversing into the body along the rotation axis, opposite the torque-tool body.
